(19) United States
(12) Patent Application Publication
(10) Pub. No.: US 2004/0210751 A1
(43) Pub. Date: Oct. 21, 2004

(54) Method for booting computer system with basic input-output system memory and structure thereof

(75) Inventor: Cheng-Chih Wang, Hsinchu (TW)

Correspondence Address: Haverstock & Owens LLP, 162 North Wolfe Road, Sunnyvale, CA, 94086, US

(73) Assignee: Winbond Electronics Corp.

(21) Appl. No.: 10/705,148

(22) Filed: Nov. 10, 2003

(30) Foreign Application Priority Data
Apr. 16, 2003 (TW) 92108855

(51) Int. Cl. G06F 15/177

(52) U.S. Cl. 713/1

(57) ABSTRACT

A method for booting a computer system by a basic input-output system memory having first and second basic input-output system is provided. The computer system includes the basic input-output system memory, a first system bus data, a control circuit, and a timer. The method includes steps of starting clocking with the timer, decoding the first system bus data to obtain a second system bus data, reading the first basic input-output system by the control circuit in response to the second system bus data, booting the computer system, and disabling the timer. If the timer can't be disabled, a time-out signal will be generated by the timer. Then, the time-out signal is received and the first system bus data is decoded into a third system bus data. Finally the computer system will be booted in response to the third system bus data.

### FIELD OF THE INVENTION

This invention relates to a method for booting a computer system, and especially to one method of using a basic input-output system memory for booting a computer system and the structure thereof.

### BACKGROUND OF THE INVENTION

A so-called basic input-output system (BIOS) is the most basic software for the basic computer operation in the present computer structure. BIOS is mainly composed of the low-level instruction sets in the computer, which is used for providing the most basic hardware checking, defining the characteristics of the computer, and managing the basic procedure in the computer operation. For instance, while the computer is booted, the BIOS runs the booting self-checking, annotates the signals from the keyboard, transmits the information between the connecting ports, and so forth. Therefore, the initial operation of computer booting is carried out by the contents of the BIOS. If some mistakes happen in the BIOS, the computer can't run the checking of the memory, the hard disk, and the central processing unity during the computer booting, then the computer can't be booted successfully.

Since the BIOS plays a decisive role in the computer system, generally the instruction program set of the BIOS is burned into a memory, such as flash read-only memory (Flash ROM), programmable read-only memory (PROM), erasable programmable read-only memory (EPROM), electrically erasable programmable read-only memory (EEPROM), and so forth, which can function for a long time without supplying any power. Therefore, such a BIOS memory is always attached on the motherboard and its contents are preserved forever without being affected by the power supply.

However, the contents of the BIOS memory are not always completely correct. For a computer operating system, some variables are necessary to be stored in the BIOS memory, hence the write-protect function of the BIOS memory cannot be enabled. As time goes by, the circuit structure of the BIOS memory will be degraded or destroyed by computer viruses, the contents of the BIOS memory may be lost or some errors may occur therein. As a result, the errors of running the BIOS instruction program set will occur while booting the computer. Therefore, the booting of the computer will not be completed.

In order to solve the above problems, some factory owners try to use two BIOS memories for overcoming the possible booting problems of the computer. As shown in FIG. 1, a block diagram illustrating the prior circuit for booting the computer system by two BIOS memories is provided. The prior circuit shown in FIG. 1 includes a main BIOS memory 11, a backup BIOS memory 12, and a watching-dog timer 13. When the computer system is booted, the watching-dog timer 13 starts to clock automatically. If the function that the computer system reads the main BIOS memory 11 through the system bus 14 is normal, the main BIOS memory 11 disables the watching-dog timer 13 and the computer system is then booted simultaneously.

As time goes by, the main BIOS memory 11 will be degraded or even destroyed by computer viruses, the contents of the BIOS memory 11 may be lost or some errors may occur therein. As a result, the errors will occur while running the BIOS instruction program set in the process of booting computer. At this time, the main BIOS memory 11 will be unable to disable the watching-dog timer 13 while booting the computer system. Therefore, the watching-dog timer 13 will keep on clocking automatically until a time-out signal is happened. When the computer system receives the time-out signal, it disables the main BIOS memory 11 and transmits an enabled input signal to the backup BIOS memory 12. Simultaneously, the computer system also sends a system reset instruction to reboot the computer system by reading the backup BIOS memory 12, so that the system is operated normally.

However, such design needs two BIOS memories, not only lots of space in the motherboard will be occupied by the BIOS memories but also the cost is much higher.

As to the above, to provide a method for booting the computer by one BIOS only, and to avoid the unnecessary increasing of the motherboard space accordingly. Further, it is another object of the present invention to provide a method to ensure the booting process of a computer system, which can be performed successfully with less cost and the structure thereof is compacter.

According to the above, a method for ensuring a successful booting process with less cost and compacter structure is badly needed for the industry.

### SUMMARY OF THE INVENTION

In accordance with one aspect of the present invention, a method for booting a computer system by a basic input-output system memory is provided. In which, the basic input-output system memory includes a first basic input-output system and a second basic input-output system. The computer system includes the basic input-output system memory, a first system bus data, a control circuit, and a timer. In addition, the method includes steps of a) starting clocking with the timer, b) decoding the first system bus data by the control circuit to obtain a second system bus data, c) reading the first basic input-output system by the control circuit in response to the second system bus data, d) booting the computer system, e) disabling the timer, f) generating a time-out signal by the timer, g) receiving the time-out signal so as to decode the first system bus data into a third system bus data, and h) booting the computer system after reading the second basic input-output system in response to the third system bus data.

Preferably, the steps g) and f) are performed by the control circuit.

Preferably, the step e) is performed by the first basic input-output system.

Preferably, the step f) is performed only when the first basic input-output system fails to disable the timer.

Preferably, the step a) is activated by a booting signal triggered by a specific key on a panel of the computer system.

Preferably, the first system bus data, the second system bus data, and the third system bus data are transmitted by one selected from a group consisting of a low pin count interface, a peripheral component interconnect interface, a firm ware hub interface and interfaces with equivalent functions.

Preferably, each of the first system bus data, the second system bus data and the third system bus data includes a cycle type data and an address data respectively.

Preferably, the step h) further includes a step of h1) generating a system reset signal by the control circuit for resetting the computer system before reading the second basic input-output system.

In accordance with another aspect of the present invention, a method for initiating a computer system by a basic input-output system memory is provided. In which, the basic input-output system memory includes a first basic input-output system and a second basic input-output system, and the computer system includes the basic input-output system memory, a first system bus data, a panel, and a timer. The method includes steps of a) decoding the first system bus data to obtain a second system bus data, b) reading the first basic input-output system in response to the second system bus data, c) initiating the computer system, d) decoding the first system bus data to obtain a third system bus data when the computer system is not initiated, and e) initiating the computer system after reading the second basic input-output system in response to the third system bus data.

Preferably, both the steps a) and b) are performed by a control circuit of the computer system.

Preferably, the steps d) and e) are performed by the control circuit, too.

Preferably, the first system bus data, the second system bus data, and the third system bus data are transmitted by one selected from a group consisting of a low pin count interface, a peripheral component interconnect interface, a firm ware hub interface and interfaces with equivalent functions.

Preferably, each of the first system bus data, the second system bus data and the third system bus data includes a cycle type data and an address data respectively.

Preferably, the step a) further includes a step of a1) starting clocking with the timer by an initiating signal coming from a key of the panel before performing the step a).

Preferably, the step c) further includes a step of c1) disabling the timer by the first basic input-output system while initiating the computer system.

Preferably, the step d) further includes steps of d1) generating a time-out signal by the timer while the first basic input-output system fails to initiate the computer system and disable the timer, and d2) receiving the time-out signal by the control circuit while decoding the first system bus data.

Preferably, the step e) further includes a step of e1) generating a system reset signal by the control circuit for resetting the computer system before reading the second basic input-output system.

In accordance with another aspect of the present invention, a method for initiating a computer system by a basic input-output system memory is provided. In which, the basic input-output system memory includes a first basic input-output system and a second basic input-output system, and the computer system includes the basic input-output system memory, a first system bus data, a second system bus data and a control circuit. The method includes steps of a) reading the first basic input-output system by the control circuit in response to the first system bus data, b) determining whether the computer system can be initiated, and c) if not, initiating the computer system after reading the second basic input-output system by the control circuit in response to the second system bus data.

Preferably, the step a) further includes steps of a1) starting clocking with a timer of the computer system according to an initiating signal generated by trigging a specific key on a panel of the computer system, a2) decoding a third system bus data of the computer system by the control circuit to obtain the first system bus data, and a3) reading the first basic input-output system by the control circuit in response to the first system bus data.

Preferably, the step b) further includes a step of b1) disabling a timer of the computer system by the first basic input-output system.

Preferably, the first system bus data, the second system bus data, and the third system bus data are transmitted by one selected from a group consisting of a low pin count interface, a peripheral component interconnect interface, a firm ware hub interface and interfaces with equivalent functions.

Preferably, each of the first system bus data, the second system bus data and the third system bus data comprises a cycle type data and an address data respectively.

Preferably, the step c) further includes steps of c1) generating a time-out signal by the timer while the first basic input-output system fails to initiate the computer system and disable the timer, c2) receiving the time-out signal by the control circuit, c3) decoding the third system bus data by the control circuit to obtain the second system bus data, c4) generating a system reset signal for resetting the computer system by the control circuit, and c5) reading the second basic input-output system by the control circuit.

In accordance with another aspect of the present invention, a structure for initiating a computer system is also provided. The structure includes a control circuit located in the computer system, and a basic input-output system memory having a first basic input-output system and a second basic input-output system, both located in the computer system and electrically connected to the control circuit. In which, the control circuit is used to initiate the computer system by reading the first input-output system, and to initiate the computer system by reading the second input-output system while failing to initiate the computer system by reading the first input-output system.

Preferably, the structure further includes a timer electrically connected to the control circuit and the basic input-output system memory respectively.

Preferably, the timer is a watching-dog timer.

Preferably, the watching-dog timer is one of a battery backup device and a non-volatile memory.

Preferably, the computer system further includes a panel with a key located thereon.

Preferably, the timer is further electrically connected to the key.

Preferably, an interface between the control circuit and the basic input-output system memory is one selected from a group consisting of a low pin count interface, a peripheral component interconnect interface, a firm ware hub interface and interfaces with equivalent functions.

Preferably, the basic input-output system memory is a flash memory.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a block diagram illustrating the circuit for booting the computer system by two BIOS memories according to the prior art; and

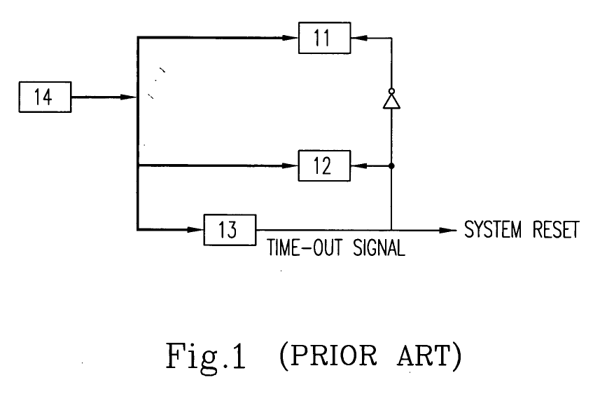

FIG. 2 is a block diagram illustrating the circuit for booting the computer system by a BIOS memory according to a preferred embodiment of the present invention.

### DETAILED DESCRIPTION OF THE PREFERRED EMBODIMENT

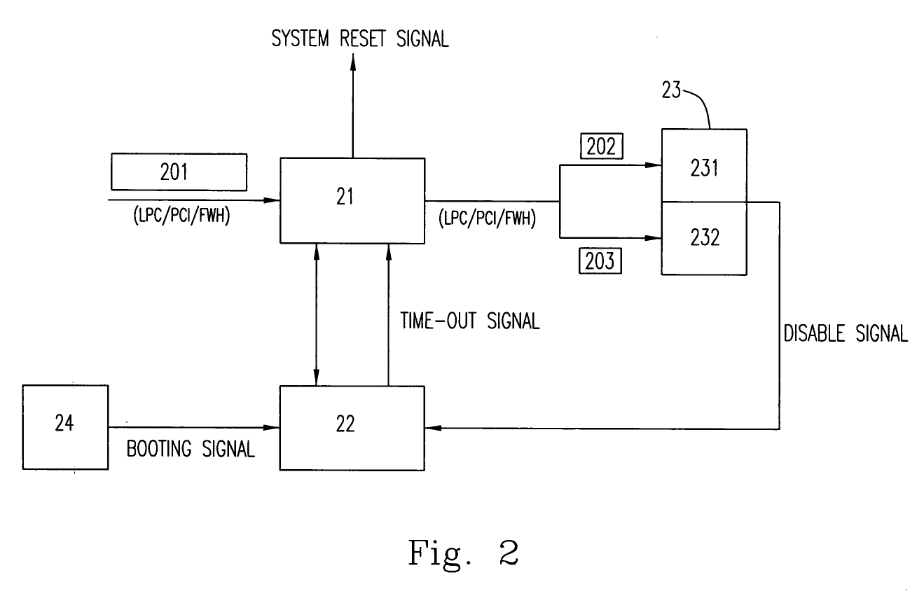

The present invention will now be described more specifically with reference to the following embodiments. Please refer to FIG. 2, which is a block diagram illustrating the circuit for booting the computer system by a BIOS memory according to a preferred embodiment of the present invention. The computer system shown in FIG. 2 includes the control circuit 21, the watching-dog timer 22, the flash memory 23, and the power key 24 located on the panel (not shown) of the computer system. In which, the flash memory 23 includes the main BIOS 231 and the backup BIOS 232, and the control circuit 21 is electrically connected to the flash memory 23 and the watching-dog timer 22 respectively. Further, the watching-dog timer 22 is electrically connected to flash memory 23 and the power key 24.

Actually, the above watching-dog timer 22 is one of a battery backup device and a non-volatile memory. After receiving the booting signal triggered from the power key 24, the watching-dog timer 22 starts clocking automatically, and the control circuit 21 decodes a first system bus data 201 to obtain a second system bus data 202. In which, the first system bus data 201 is transmitted by one interface selected from a group consisting of a low pin count interface, a peripheral component interconnect interface, a firm ware hub interface and the interfaces with equivalent functions. The first system bus data 201 further includes the cycle type data and the address data. The second system bus data 202 is then transmitted by another interface for instructing the computer system to read the main BIOS 231 for continuously proceeding the booting procedure. The foregoing interface is selected from a group consisting of a low pin count interface, a peripheral component interconnect interface, a firm ware hub interface and the interfaces with equivalent functions. After the main BIOS 231 is successfully read by the computer system, the main BIOS 231 sends a disable signal to the watching-dog timer 22 for stopping the clocking and the booting procedure is completed.

During the above booting procedure, if the main BIOS 231 can not be operated normally owing to a virus attack, a rewrite or an artificial destruction, the computer system will not be booted and the watching-dog timer 22 will not be disabled by the main BIOS 231. Then, a situation of time-out will happen to the watching-dog timer 22, and the watching-dog timer 22 will send the time-out signal to the control circuit 21. After receiving the time-out signal, the control circuit 21 will send a system reset signal to the computer system so as to decode the first system bus data 201 into a third system bus data 203, wherein the contents of the third system bus data 203 are different from those of the first system bus data 201 and the second system bus data 202.

Since the address data of the third system bus data 203 are different from those of the second system bus data 202, the third system bus data 203 can be transmitted by the same interfaces of the second system bus data 202 for indicating the computer system to read the backup BIOS 232 only. Therefore, after reseting, the computer system will carry out the booting procedure via reading the backup BIOS 232 successfully.

As described above, the present invention provides a method for booting a computer system by a BIOS memory having a main BIOS and a backup BIOS and the method thereof. By operating the watching-dog timer and the particular control circuit, it is possible to decode the data transmitted from the system bus and to get the relevant address data no matter the BIOS memory is normal or not. That is to say the computer system will read the main BIOS when the main BIOS memory is normal, or will read the backup BIOS when the main BIOS memory is out of order. As a result, the booting procedure of the computer system will not be affected by the abnormal functioning of the main BIOS memory.

Most importantly, the computer system of the present invention only includes one single flash memory. Compared with the prior art, the present invention reduces the space of the motherboard and the cost for buying the second BIOS memory. Thus, the present invention does effectively improve the defaults of the prior arts and has the novelty, progressiveness, and is valuable for the industries.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A method for booting a computer system by a basic input-output system memory, wherein said basic input-output system memory comprises a first basic input-output system and a second basic input-output system, and said computer system comprises said basic input-output system memory, a first system bus data, a control circuit, and a timer, comprising steps of:
a) starting clocking with said timer;
b) decoding said first system bus data by said control circuit to obtain a second system bus data;
c) reading said first basic input-output system by said control circuit in response to said second system bus data;
d) booting said computer system;
e) disabling said timer;
f) generating a time-out signal by said timer;
g) receiving said time-out signal so as to decode said first system bus data into a third system bus data; and
h) booting said computer system after reading said second basic input-output system in response to said third system bus data.

2. The method as claimed in claim 1, wherein said steps g) and f) are performed by said control circuit.

3. The method as claimed in claim 1, wherein said step e) is performed by said first basic input-output system.

4. The method as claimed in claim 1, wherein said step f) is performed only when said first basic input-output system fails to disable said timer.

5. The method as claimed in claim 1, wherein said step a) is activated by a booting signal triggered by a specific key on a panel of said computer system.

6. The method as claimed in claim 1, wherein said first system bus data, said second system bus data, and said third system bus data are transmitted by one selected from a group consisting of a low pin count interface, a peripheral component interconnect interface, a firm ware hub interface and interfaces with equivalent functions.

7. The method as claimed in claim 6, wherein each of said first system bus data, said second system bus data and said third system bus data comprises a cycle type data and an address data respectively.

8. The method as claimed in claim 1, wherein said step h) further comprises a step of h1) generating a system reset signal by said control circuit for resetting said computer system before reading said second basic input-output system.

9. A method for initiating a computer system by a basic input-output system memory, wherein said basic input-output system memory comprises a first basic input-output system and a second basic input-output system, and said computer system comprises said basic input-output system memory, a first system bus data, a second system bus data and a control circuit, comprising steps of:
a) reading said first basic input-output system by said control circuit in response to said first system bus data;
b) determining whether said computer system can be initiated; and
c) if not, initiating said computer system after reading said second basic input-output system by said control circuit in response to said second system bus data.

10. The method as claimed in claim 9, wherein said step a) further comprises steps of:
a1) starting clocking with a timer of said computer system according to an initiating signal generated by trigging a specific key on a panel of said computer system;
a2) decoding a third system bus data of said computer system by said control circuit to obtain said first system bus data; and
a3) reading said first basic input-output system by said control circuit in response to said first system bus data.

11. The method as claimed in claim 10, wherein said step b) further comprises a step of b1) disabling a timer of said computer system by said first basic input-output system.

12. The method as claimed in claim 11, wherein said first system bus data, said second system bus data, and said third system bus data are transmitted by one selected from a group consisting of a low pin count interface, a peripheral component interconnect interface, a firm ware hub interface and interfaces with equivalent functions.

13. The method as claimed in claim 11, wherein said step c) further comprises steps of:
c1) generating a time-out signal by said timer while said first basic input-output system fails to initiate said computer system and disable said timer;
c2) receiving said time-out signal by said control circuit;
c3) decoding said third system bus data by said control circuit to obtain said second system bus data;
c4) generating a system reset signal for resetting said computer system by said control circuit; and
c5) reading said second basic input-output system by said control circuit.

14. A structure for initiating a computer system, comprising:
a control circuit located in said computer system; and
a basic input-output system memory having a first basic input-output system and a second basic input-output system, located in said computer system and electrically connected to said control circuit,
wherein said control circuit is used to initiate said computer system by reading said first input-output system, and to initiate said computer system by reading said second input-output system while failing to initiate said computer system by reading said first input-output system.

15. The structure as claimed in claim 14 further comprising a timer electrically connected to said control circuit and said basic input-output system memory respectively.

16. The structure as claimed in claim 15, wherein said timer is a watching-dog timer selected from a battery backup device and a non-volatile memory.

17. The structure as claimed in claim 16, wherein said timer is further electrically connected to a key located on said computer system.

18. The structure as claimed in claim 14, wherein an interface between said control circuit and said basic input-output system memory is one selected from a group consisting of a low pin count interface, a peripheral component interconnect interface, a firm ware hub interface and interfaces with equivalent functions.

19. The structure as claimed in claim 14, wherein said basic input-output system memory is a flash memory.
